(19) United States
(12) Patent Application Publication
(10) Pub. No.: US 2025/0207649 A1
(43) Pub. Date: Jun. 26, 2025

(54) ELECTROMECHANICALLY ACTUATABLE BRAKE PISTON ASSEMBLY

(71) Applicant: ZF Active Safety GmbH, Koblenz (DE)

(72) Inventors: Lukas Madzgalla, Lahnstein (DE); Marco Becker, Oberdürenbach (DE); Florian Roessinger, Neuwied (DE)

(73) Assignee: ZF Active Safety GmbH, Koblenz (DE)

(21) Appl. No.: 18/985,401

(22) Filed: Dec. 18, 2024

(30) Foreign Application Priority Data
Dec. 20, 2023 (DE) 102023135911.8

(51) Int. Cl. F16D 65/18; F16D 65/00; F16D 121/24; F16D 125/36; F16D 125/40

(52) U.S. Cl. CPC F16D 65/18; F16D 65/0068; F16D 2121/24; F16D 2125/36; F16D 2125/40

(57) ABSTRACT

The present disclosure relates to an electromechanically actuatable brake piston assembly for a motor vehicle disc brake, comprising: a brake calliper housing having a bridge, bridge fingers and a brake piston bearing portion; a brake piston which can be axially moved in a first bore of the brake piston bearing portion, said first bore having a bore axis and a first bore wall; a rotation-translation transmission installed in an internal space of the brake piston; and an anti-rotation mechanism having a guide slot and a guide element, which is guided by the guide slot in such a way that the brake piston is limited to its axial degree of freedom of motion. The guide slot is comprised of the brake piston bearing portion and the guide element is fixedly connected to the brake piston.

### CROSS-REFERENCE TO RELATED APPLICATIONS

This application claims priority to German Patent Application No. 102023135911.8, filed Dec. 20, 2023, the disclosure of which is incorporated herein by reference in its entirety.

### TECHNICAL FIELD

The present disclosure relates to an electromechanically actuatable brake piston assembly for a motor vehicle disc brake. The disclosure also relates to a motor vehicle disc brake having a brake piston assembly of the electromechanically actuatable type and having an electromechanical drive, and the disclosure concerns a partial method in manufacturing of a brake piston assembly of the electromechanically actuatable type.

### BACKGROUND

An electromechanically actuatable brake piston assembly is used to support a brake piston for axial movement, the brake piston being accommodated in a guide bore of a brake piston bearing portion of a brake calliper housing, and to provide the brake piston such that it can be actuated by an electromechanical drive. In this way, the brake piston can transfer a pressing force to brake pads, which in turn can press against a brake rotor with a pressing force and can brake the brake rotor.

The prior art discloses electromechanically actuatable brake piston assemblies for motor vehicle disc brakes in which a rotation-translation transmission is accommodated in the brake piston and in which the brake piston is supported in a brake piston bearing portion of the brake calliper housing such that the brake piston is axially movable and can be actuated by an electromechanical drive. The prior art also discloses providing an anti-rotation mechanism for the brake piston in such a brake piston assembly, so that, when the brake piston assembly is actuated, the brake piston does not rotate concomitantly, but rather moves in the axial direction.

Once such example, is DE 10 2022 119 398 A1, which is concerned with an electromechanically driven brake piston assembly and also with a corresponding motor vehicle disc brake.

### SUMMARY

What is needed is to provide an electromechanically actuatable brake piston assembly for a motor vehicle brake which can be more economically manufactured, is relatively easy to assemble and functions reliably in operation. In addition, a corresponding motor vehicle disc brake that may be economically manufactured, and assembled with ease is also needed. A partial method in the context of manufacturing an electromechanically actuatable brake piston assembly, for which partial method the manufacturing costs are low and also relatively easy assembly is also needed.

A brake piston assembly is disclosed herein. In addition, a motor vehicle disc brake is also proposed, as well as a manufacturing method. Additional, exemplary arrangements of the disclosure may be found in the dependent claims.

The electromechanically actuatable brake piston assembly according to the disclosure is provided for a motor vehicle disc brake and has a brake calliper housing. When in the description below merely the term “brake piston assembly” is used, without the preceding expression “electromechanically actuatable”, for the sake of better readability, this should always be understood to mean an electromechanically actuatable brake piston assembly. In one exemplary arrangement, the brake calliper housing comprises a bridge, bridge fingers and a brake piston bearing portion. Since brake calliper housings are well known from the prior art, the brake calliper housing does not need to be described in more detail here. Of course, the brake calliper housing of the present disclosure can lie within the scope of the known arrangements. For example, the brake calliper housing could be designed such that the brake piston bearing portion is connected to two bridge fingers by the bridge, the bridge fingers being located on the outside of an associated motor vehicle disc brake and the brake piston bearing portion of the brake calliper housing being oriented toward the inside, i.e. toward the chassis, of an associated vehicle.

The brake piston assembly also comprises a brake piston axially movable in a first bore of the brake piston bearing portion, said first bore having a bore axis and a first bore wall, and a rotation-translation transmission installed in an internal space of the brake piston. In one exemplary arrangement, the rotation-translation transmission is a screw drive. The brake piston assembly also comprises an anti-rotation mechanism. The anti-rotation mechanism has a guide slot, which is comprised by the brake piston bearing portion, and a guide element, which is fixedly connected to the brake piston. In one exemplary arrangement, the guide element is pressed into the piston. In this case, the piston has in its lateral surface a recessed cavity into which the guide element is inserted, and in which the guide element is held by a press fit, adhesive bonding or some other type of connection, e.g. screwing. In one exemplary arrangement, the guide element is a feather key or a slot block or a guide pin. The guide element may be guided by the guide slot in such a way that the brake piston is limited to its axial degree of freedom of motion. That is, the brake piston can be moved axially, for example by actuation of the brake piston assembly. In contrast, rotation of the brake piston is restricted or prevented by the anti-rotation mechanism. As a result of the introduction of a guide slot into the brake piston bearing portion and the coupling of the guide element to the brake piston, better assembly is achieved.

The expression “axial” or in the “axial direction” relates to the orientation of the bore axis. I.e., “axial” means running parallel to the bore axis or along this axis.

In one exemplary arrangement, the brake calliper housing is a monolithic casting. Such a design, in which the guide slot is introduced directly into the casting, is a brake piston assembly which can be manufactured economically.

In one exemplary arrangement, the brake piston has a lateral surface which, for guidance of the brake piston, is in direct contact with the first bore wall. That is, no additional guide elements, e.g. guide bush, are needed here to support and guide the brake piston. This too has a favourable effect on the manufacturing costs.

In one exemplary arrangement, the rotation-translation transmission is a screw drive, for example, a ball screw drive without self-locking. In this case, the brake piston has a cylindrical inner wall which defines the internal space of the brake piston. That is, the internal space of the brake piston is delimited by the cylindrical inner wall. The internal space can be delimited by additional wall regions, e.g. by an end wall of the brake piston, which, when the brake piston assembly is installed in a motor vehicle disc brake, is directed toward a brake pad or toward the brake disc. The brake piston is in the form of a screw nut, and the thread or the threads are formed in the inner wall. In the case of a ball screw drive, the corresponding ball raceway or the ball raceways are formed in the inner wall. This design, too, contributes to a reduction in the manufacturing costs similarly to the guide slot introduced into the brake piston bearing portion and similarly to the use of the first bore wall to guide the brake piston, because more functions are implemented in fewer components. In one exemplary arrangement, the ball raceway or the ball raceways directly cooperate, by the use of corresponding balls, with a screw placed in the brake piston, which screw can likewise have one or more ball raceways.

In one exemplary arrangement, the guide slot is formed in the first bore wall and recesses the first bore wall accordingly. Regarding the resulting advantages, reference is made to the preceding paragraph in which the advantages were already presented.

In one exemplary arrangement, the guide slot is in the form of an elongate hole, a longitudinal axis of which is oriented parallel to the bore axis of the first bore. In this case, the guide slot in the form of the elongate hole penetrates the brake piston bearing portion from the exterior of the brake piston bearing portion, in the radial direction toward the bore axis, to the first bore. The guide element is at least partly accommodated in the guide slot. The exterior of the brake piston bearing portion is directed toward the surroundings of the brake calliper housing and is formed by corresponding surfaces. Thus, the exterior of the brake piston bearing portion is located where the brake calliper housing is delimited, in the region of the brake piston bearing portion, toward the surroundings. Such a penetrating guide slot, in the form of an elongate hole, is relatively easy to produce and thus contributes to cost reduction.

In one exemplary arrangement, the brake piston bearing portion has a recess which is introduced into the exterior (the term “exterior” is described in the preceding paragraph) of the brake piston bearing portion and which has a recess bottom sunk into the brake piston bearing portion and a recess wall connecting the recess bottom and the exterior, so that the guide slot forms a through-hole between the recess bottom and the first bore, the recess being closed to the outside by a cover. During the assembling of the brake piston assembly, the recess can be closed with such a cover. The cover protects the anti-rotation mechanism and thus also the brake piston, the rotation-translation transmission and the first bore from contaminants and thus ensures reliable function during operation of the brake piston assembly and of an associated motor vehicle disc brake.

In one exemplary arrangement, the recess wall is cylindrical with a first inside diameter Di1.

In one exemplary arrangement, the cover has a cover edge notched by at least one slit which proceeds from the cover edge and which extends toward the cover centre, so that the diameter of the cover edge is elastically variable.

In one exemplary arrangement, the cover has a cover edge notched by at least five slits which proceed from the cover edge and extend toward the cover centre and are mutually spaced apart. In one exemplary arrangement, the slits are evenly distributed over 360°, so that the diameter of the cover edge is elastically variable.

In one exemplary arrangement, the cover has a planar inner cover portion which, in the installed state, covers the guide slot, wherein the cover edge surrounds the inner cover portion and protrudes from the inner cover portion by means of at least one first bent part, and wherein the at least one slit or the at least five slits at least partly notch the bent part. By virtue of an elastic cover edge of this type and by virtue of the nature of the slits in cooperation with the bent part, the cover can be easily inserted into the recess and yet is securely held in the recess.

When the term “bent part” is used in connection with the present disclosure, such a bent part can comprise a simple change in direction of the cover edge relative to the inner cover portion; however, it can also comprise an additional change in direction or additional changes in direction of the cover edge of the bent portion relative to the already bent portion of the cover edge. For example, a first portion of the cover edge can protrude from the planar inner cover portion at an angle, e.g. at a 90° angle, and an additional portion of the cover edge can in turn protrude at an angle, e.g. a 90° angle, relative to the already bent first portion of the cover edge. The preceding description of a bent part is based on a view of the cover edge or of the cover in half-section, in which the cover edge can be seen in profile. The term “bent part” is also not so much an indication of a specific method for manufacturing the cover and the cover edge; rather, it is used to describe the shape of the cover edge. Thus, the term “bent part” here also encompasses bent parts that extend along a round cover edge.

In one exemplary arrangement, the cover edge is shaped such that the cover edge can be inserted into the recess because of the elastic deformation of the cover edge and that the cover can be pulled out against the insertion direction only with plastic deformation of the cover edge.

In one exemplary arrangement, the recess has an annular groove having a groove base or has a bore offset portion having a second bore wall, the groove base or the second bore wall having a second inside diameter Di2 which is greater than the first inside diameter Di1, and the cover, in the inserted state, being form-lockingly held by its cover edge in the annular groove or in the bore offset portion, and in this position the outside diameter of the cover edge being greater than the first inside diameter Di1.

In one exemplary arrangement, the cover edge has, when not inserted in the recess, a first outside diameter Da1 and, when inserted in the recess, a second outside diameter Da2 which is less than the first outside diameter Da1, the cover edge being clamped in the recess wall when inserted in the recess. In the case of this clamping, the cover edge can also press into the recess wall. The cover and the cover edge and optionally a bent part can be designed such that the clamping force increases as an axial force acting against the insertion direction of the cover increases.

In one exemplary arrangement, the brake piston assembly comprises a seal which, together with the cover, seals off the first bore from the surroundings of the brake piston assembly. The sealing which can be achieved in this way protects the anti-rotation mechanism and thus also the brake piston, the rotation-translation transmission and the first bore from contaminants and thus ensures reliable function during operation of the brake piston assembly and of an associated motor vehicle disc brake.

In one exemplary arrangement, the seal is made of an elastically deformable elastomer, such as, for example, a rubber.

In one exemplary arrangement, in the installed state the seal applies a force to the cover as a result of elastic deformation. In one exemplary arrangement, in the installed state the seal applies a force to the cover as a result of elastic deformation in the axial direction. This contributes to ideal sealing of the cover and securing of the position of the cover. Thus, this leads to ease of assembly and reliable functioning of the brake piston assembly and of an associated motor vehicle disc brake.

In one exemplary arrangement, the seal is annular and has a round or oval or polygonal, e.g. rectangular, cross section. The seal is placed between the recess bottom and the first bent part or between the recess bottom and a second bent part which the cover edge comprises and which is located between the first bent part and the inner cover portion. Similarly to the above-described possible design of the first bent part, the second bent part likewise can comprise a first and additional changes in direction of a portion of the cover edge.

In one exemplary arrangement, at least most of the inner cover portion is planar. In this case, the second bent part comprises an annular-disc-shaped portion, and the planar inner cover portion and the annular-disc-shaped portion of the second bent part are oriented parallel to one another.

In one exemplary arrangement, the seal is annular and has a round or oval or polygonal, e.g. rectangular, cross section. The seal is placed between the recess wall and the first bent part or between the recess wall and a second bent part which the cover edge comprises and which is located between the first bent part and the inner cover portion.

In one exemplary arrangement, the seal is disc-shaped and is arranged between the recess bottom and the cover, for example the inner cover portion. Alternatively, the seal is disc-shaped and is arranged between the recess bottom and a pressing disc, which is comprised by the electromechanically actuatable brake piston assembly and which is seated against the cover.

In all described exemplary arrangements of the cover, the cover may be produced from a sheet and in one exemplary arrangement, from a metal sheet. Such covers are economical and contribute to the cost optimization of the brake piston assembly.

The motor vehicle disc brake according to the disclosure comprises a brake bracket, an electromechanical drive, which has a transmission assembly and an electric motor, and a brake piston assembly according to the aforementioned exemplary arrangements with the corresponding components, features and advantages, which brake piston assembly can be actuated by the electromechanical drive.

The partial method according to the disclosure in the manufacturing of an electromechanically actuatable brake piston assembly according to the aforementioned exemplary arrangements comprises at least the following method steps:
a) introducing, for example by milling, the guide slot, which may be in the form of an elongate hole, proceeding from the exterior of the brake piston bearing portion, in the radial direction toward the bore axis, to the first bore,
b) drilling, spindling, turning or milling the recess or drilling, spindling, turning or milling the recess and the annular groove or the bore offset portion,
c) inserting the seal into the first recess or mounting the seal on the cover,
d) inserting the cover into the recess and locking the cover edge in the annular groove or in the bore offset portion or inserting the cover into the recess and clamping the cover edge to the first recess wall.

Alternatively, the partial method according to the disclosure comprises at least the following method steps:
method steps a) to d) according to the preceding paragraph, method step b) being carried out before method step a).

The partial method according to the disclosure has the advantage that the guide slot can be produced easily and economically. Also, the assembly sequence is advantageous.

Other features, advantages and possible applications of the present invention are clear from the following description of the exemplary arrangements and from the schematic FIGS. 1 to 11. For the sake of clarity, not always all elements shown in a figure are also provided with a reference sign. However, corresponding elements or regions are then at least marked in another figure and the meaning can be taken from there. And, in the figures, identical reference signs can represent the same or similar objects.

### BRIEF DESCRIPTION OF THE DRAWINGS

FIG. 1 shows the design of a brake piston assembly in an overall view and presents a first exemplary arrangement of the disclosure.

FIG. 2 shows a detail of a brake piston assembly according to the disclosure.

FIG. 3 shows two illustrations of a second exemplary arrangement of the brake piston assembly according to the disclosure.

FIG. 4 shows another illustration of the second exemplary arrangement of the brake piston assembly according to the disclosure.

FIG. 5 shows an illustration of a third exemplary arrangement of the brake piston assembly according to the disclosure.

FIG. 6 shows two illustrations of a fourth exemplary arrangement of the brake piston assembly according to the disclosure.

FIG. 7 shows another illustration of the fourth exemplary arrangement of the brake piston assembly according to the disclosure.

FIG. 8 shows an illustration of a fifth exemplary arrangement of the brake piston assembly according to the disclosure.

FIG. 9 shows an illustration of a sixth exemplary arrangement of the brake piston assembly according to the disclosure.

FIG. 10 shows two illustrations of a seventh exemplary arrangement of the brake piston assembly according to the disclosure.

FIG. 11 shows an illustration of an exemplary arrangement of the motor vehicle disc brake according to the disclosure.

### DETAILED DESCRIPTION

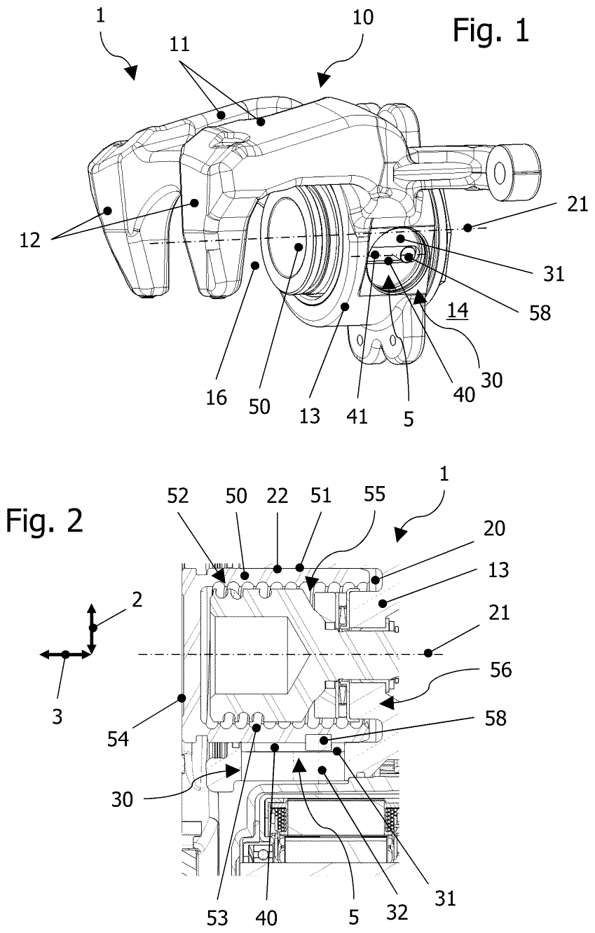

FIGS. 1 and 2 show the design of a brake piston assembly 1 according to the disclosure. In the illustrated state of the brake piston assembly 1, the region of the anti-rotation mechanism 5 is not closed to the outside, so that the anti-rotation mechanism 5 is visible. The brake piston assembly 1 comprises a brake calliper housing 10 having: a bridge 11, two bridge fingers 12 and a brake piston bearing portion 13. The brake disc shaft 16, in which, when the brake piston assembly 1 and the associated motor vehicle disc brake 100 are installed on a vehicle or on a vehicle axle, a brake disc is placed and can rotate, is located between the bridge fingers 12 and the brake piston bearing portion 13. The brake piston bearing portion 13 is part of a monolithic brake calliper housing 10 which may be produced as a casting.

The brake piston bearing portion 13 has a first bore 20 having a bore axis 21 and having a bore wall 22. A brake piston 50 is axially movably supported in the first bore 20. The brake piston 50 exits from the brake piston bearing portion 13, i.e. from the brake calliper housing 10, on the side of the brake piston bearing portion 13 oriented toward the brake disc shaft 16, so that the brake piston can apply, by its end wall 54, an actuation force to the brake pads and to the brake disc. The brake piston 50 has a lateral surface 51, which is in sliding contact with the bore wall 22.

A guide element 58 in the form of a cylindrical body is set into the brake piston 50 and in one exemplary arrangement, into the lateral surface 51. FIGS. 1 and 2 show this in basic form. The guide element 58 can be fastened in the brake piston 50 in different ways. In one exemplary arrangement, the guide element 58 is screwed into the brake piston 50. But the guide element 58 can also be fastened in the brake piston 50 in any other way. The guide element 58 is part of an anti-rotation mechanism 5, by which rotation of the brake piston 50 is prevented but which permits and enables axial movement of the brake piston 50. The guide element 58 thus acts as a guide block or slot block which is guided in a corresponding guide slot 40. The guide slot 40 is formed or recessed into the brake piston bearing portion 13 of the brake calliper housing 10 in the form of an elongate hole. The guide slot 40 is therefore shaped and oriented to guide the guide element 58 and thus the brake piston 50 translationally.

Where the anti-rotation mechanism 5 is located, there is also a recess 30 introduced into the exterior 14 of the brake piston bearing portion 13. Said recess 30 is in the form of a cylindrical depression and is depressed radially toward the bore axis 21 from the exterior 14. The recess 30 thus has a recess bottom 31, which is closer to the first bore 20 or to the bore axis 21 of the first bore than the exterior 14 is, and a recess wall 32, in the present case a cylindrical recess wall having a first inside diameter Di1. A detailed description of the recess 30 follows later in the description.

The elongate hole constituting the guide slot 40 forms a through-hole between the recess bottom 31 and the bore wall 22. The elongate hole 40 penetrates the brake piston bearing portion 13 in the radial direction. The longitudinal axis 41 of the elongate hole 40 is oriented parallel to the bore axis 21 of the first bore 20. Such a guide slot can be relatively simply machined from the exterior 14 of the brake piston bearing portion 13, because the region is easily accessible for corresponding tools. The guide element 58 extends into the guide slot 40 and is guided by the straight side walls of the elongate hole 40 such that the brake piston 50 can move only in the axial direction 3.

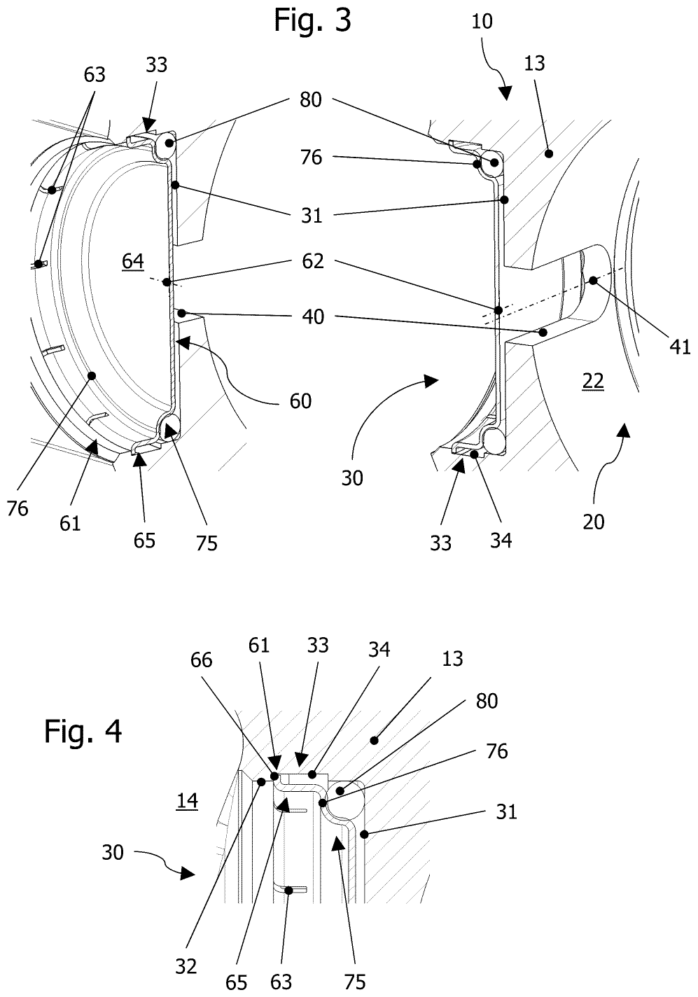

FIGS. 3 to 11 show further exemplary arrangements of the disclosure. The focus is on the design of the recess 30 and of the cover 60. The brake piston assembly 1 corresponds overall to the exemplary arrangement of the brake piston assembly 1 that was already described above on the basis of FIGS. 1 and 2. Since the figures contain schematic illustrations, the seal 80 is not always illustrated in the shape it would have in reality. Thus, material overlaps possibly shown in the illustrations are also merely the result of drawing and would not result in such a way in reality.

FIGS. 3 and 4 each show a portion of a second exemplary arrangement of the brake piston assembly 1 according to the disclosure. The recess 30 has a recess bottom 31 and a cylindrical recess wall 32. The elongate hole 40 forms a through-hole between the recess bottom 31 and the bore wall 22. An annular groove 33, the groove base 34 of which has a second inside diameter Di2 which is greater than the first inside diameter Di1 of the cylindrical recess wall, is formed in the recess wall 32. A cover 60 is inserted into the recess 30.

The cover 60 is a plate-type structure which is produced from a metal sheet and which has a flat and planar inner cover portion 64. A cover edge 61 extends around said inner cover portion 64. The cover edge 61 has two bent parts 65 and 75, which are shaped as follows. The first bent part 65 is formed by a flange 66, which is directed radially outward and is oriented substantially parallel to the inner cover portion 64. Said flange is adjoined by a sheet portion which extends in the axial direction and which is oriented perpendicularly to the flange 66. The joint between the flange 66 and the sheet portion extending in the axial direction is formed as a radius. The second bent part 75 is located between the first bent part 65 and the inner cover portion 64. Via a joint formed as a radius, the second bent part adjoins the aforementioned sheet portion extending in the axial direction. The second bent part 75 has an annular-disc-shaped portion 76, which is oriented parallel to the inner cover portion 64 and is connected to the inner cover portion 64 by another sheet portion extending in the axial direction. All joints between the individual sheet portions or bent-part portions are in the form of radii.

A plurality of slits 63 each running in the radial direction 2 notch the cover edge 61 at its outermost contour. The slits 63 notch the cover edge 61 into the first bent part 65. The slits 63 are evenly distributed over the 360° of the cover edge 61. The slits 63 create individual cover edge segments, and as a result the outside diameter of the cover edge 61 can be elastically deformed, for example can be elastically reduced in size, resulting in favourable installability of the cover.

An o-ring, i.e. an annular seal 80 having a round cross section, is arranged between the annular-disc-shaped portion 76 and the recess bottom 31. Said seal seals off the first bore 20, the anti-rotation mechanism 5, the rotation-translation transmission 56 and other parts from the surroundings. The seal 80 has contact with the annular-disc-shaped portion 76 of the cover 60, the recess bottom 31 and the recess wall 32 and is pressed in between these elements by virtue of the assembly process and thus achieves the sealing effect as well as reliable positioning of the cover, since in this way the cover edge 61 is pressed form-lockingly against a groove wall of the annular groove 33.

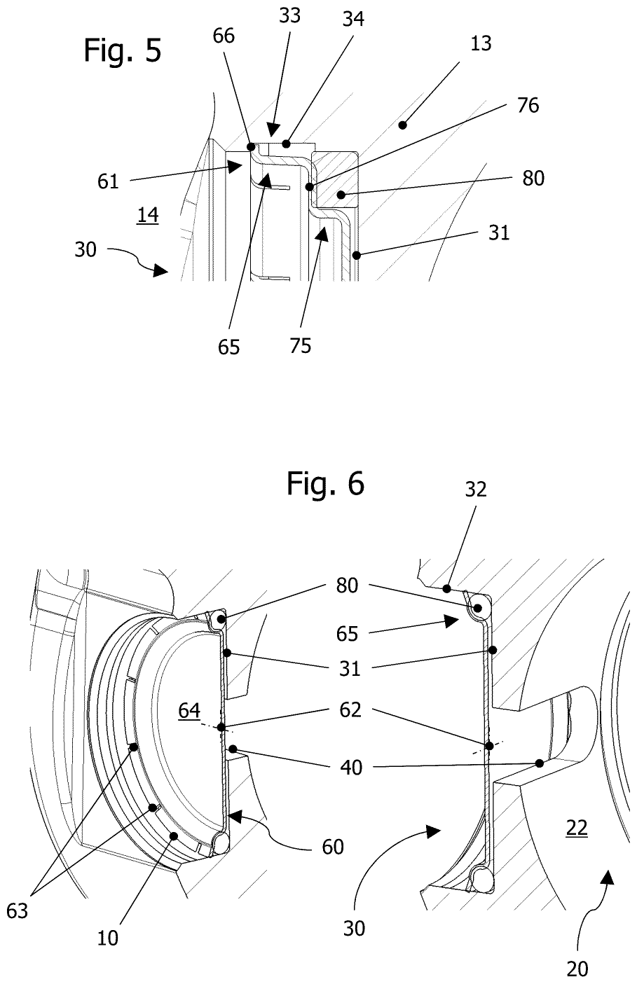

FIG. 5 shows a portion of a third exemplary embodiment of the brake piston assembly 1 according to the invention. This third exemplary embodiment differs from the second exemplary embodiment merely in the cross-sectional shape of the seal 80. Here, instead of being round, the cross section is square or rectangular (depending on the compression state). This embodiment of the sealing ring 80 provides a higher preload force which acts on the cover 60 when the seal 80 is compressed. The design of the brake piston assembly 1 is otherwise identical to the second exemplary arrangement and does not need to be described again here.

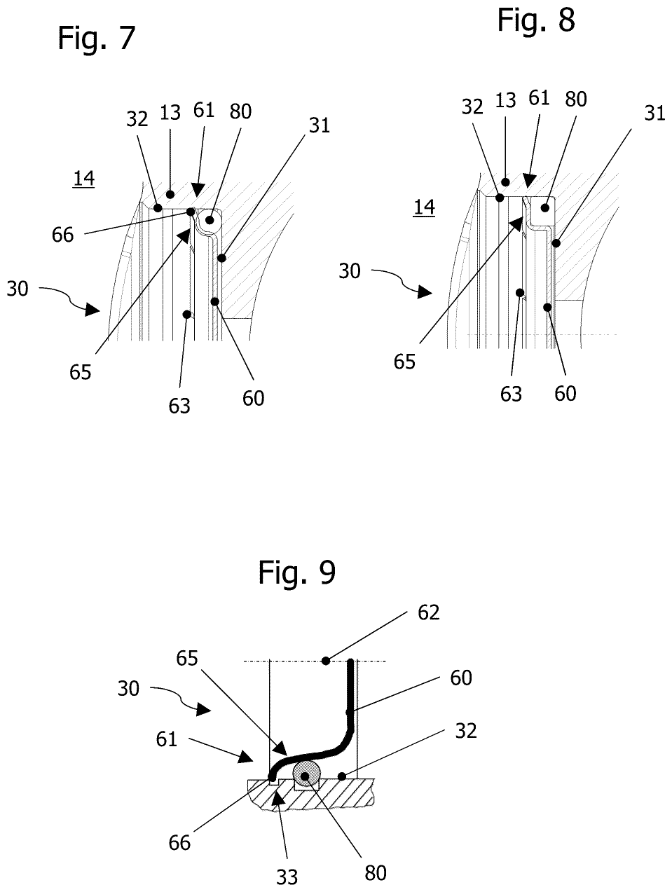

FIGS. 6 and 7 each show a portion of a fourth exemplary arrangement of the brake piston assembly 1 according to the disclosure. This fourth exemplary arrangement differs from the second exemplary arrangement in that the recess 30 does not have an annular groove. That is, the recess 30 is formed by the recess bottom 31 and the recess wall 32. Also, the cover edge 61 of the cover 60 has only a first bent part 65. Said first bent part 65 has an annular-disc-shaped portion 76, which is parallel and offset to the inner cover portion 64 and which is connected to the inner cover portion 64 by means of an axially extending sheet portion. Toward the outside, the annular-disc-shaped portion 76 is adjoined by a flange 66, which extends both in the radial direction and in the axial direction, so that by the flange 66, the outermost contour of the cover edge 61 is pressed and clamped into the recess wall 32. The shape of the cover 60 of this fourth exemplary arrangement is less complex and therefore more economical than the shape of the second exemplary arrangement. The situation is similar with the recess 30. Likewise in the cover 60 of this fourth exemplary arrangement, slits 63 are notched into the cover edge 61. The more detailed description of the slits and their arrangement corresponds to the description of the slits of the second exemplary arrangement.

An o-ring, i.e. an annular seal 80 having a round cross section, is arranged between the annular-disc-shaped portion 76 and the recess bottom 31. Said seal seals off the first bore 20, the anti-rotation mechanism 5, the rotation-translation transmission 56 and other parts from the surroundings. The seal 80 has contact with the annular-disc-shaped portion 76 of the cover 60, the recess bottom 31 and the recess wall 32. The seal 80 is pressed in between these elements by virtue of the assembly process and thus achieves the sealing effect as well as reliable positioning of the cover, since the cover edge 61 is pressed against and into the recess wall 32.

FIG. 8 shows a portion of a fifth exemplary arrangement of the brake piston assembly 1 according to the disclosure. This fifth exemplary arrangement differs from the fourth exemplary arrangement merely in the cross-sectional shape of the seal 80. Here, instead of being round, the cross section is square or rectangular (depending on the compression state). The design of the brake piston assembly 1 is otherwise identical to the fourth exemplary arrangement and does not need to be described again here.

FIG. 9 shows a portion of a sixth exemplary arrangement of the brake piston assembly 1 according to the disclosure. In this exemplary arrangement, between a substantially or at least predominantly axially oriented sheet portion of a first bent part 65 of the sheet edge 61 and the recess wall 32, or an annular groove set into the recess wall 32, the seal 60 seals off the first bore 20, the anti-rotation mechanism 5, the rotation-translation transmission 56 and other parts from the surroundings of the brake piston assembly 1. Due to a flange 66 which is directed radially outward and which adjoins the substantially or at least predominantly axially oriented sheet portion, the cover edge 61 is held in an annular groove 33 set into the recess. In this exemplary arrangement, the size of the annular groove 33 is such that the position of the cover 60 is secured.

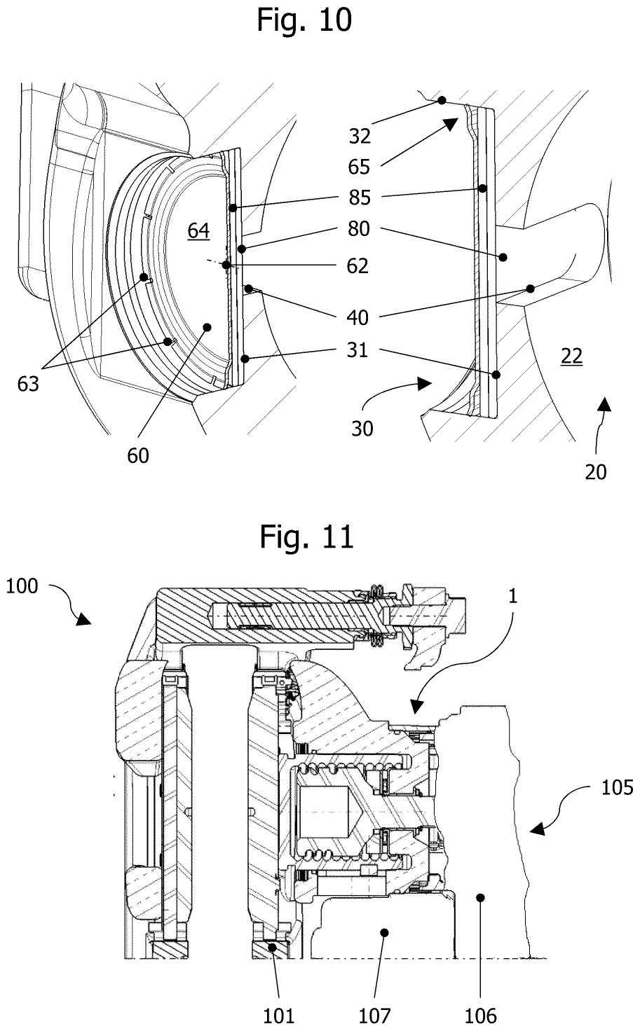

In a seventh exemplary arrangement, which is shown in FIG. 10, the seal 60 is in the form of a disc-shaped element, which is laid onto the recess bottom 31 and covers the recess bottom and the guide slot 40. Here, the cover 60 has the same design as in the fourth and fifth exemplary arrangements. Between the inner cover portion 64 and the seal 60, there is a pressing disc 85. The seal package thus formed, comprising the cover 60, the pressing disc 85 and the seal 60, provides the sealing. The holding of the cover 60 by the elastic cover edge 61 occurs in the same way as in the previously described exemplary arrangements and does not need to be described again here.

FIG. 11 shows an exemplary arrangement of the motor vehicle disc brake according to the disclosure. The brake calliper housing 10 and thus also the brake piston assembly 1 are supported for axial movement relative to the brake bracket 101 and are connected to the brake bracket. An electromechanical drive 105, comprising a transmission assembly 106 and an electric motor 107, is coupled to the brake piston assembly 1, for example to the brake piston bearing portion 13 of the brake calliper housing 10, and is used to actuate the brake piston 50.

1. An electromechanically actuatable brake piston assembly for a motor vehicle disc brake, comprising:
a brake calliper housing having a bridge, bridge fingers and a brake piston bearing portion,
a brake piston which is axially movable in a first bore of the brake piston bearing portion, said first bore having a bore axis and a first bore wall,
a rotation-translation transmission installed in an internal space of the brake piston,
and an anti-rotation mechanism having a guide slot and a guide element, which is guided by the guide slot in such a way that the brake piston is limited to its axial degree of freedom of motion,
wherein the guide slot is comprised by the brake piston bearing portion and the guide element is fixedly connected to the brake piston.

2. The electromechanically actuatable brake piston assembly according to claim 1, wherein the brake calliper housing is a monolithic casting.

3. The electromechanically actuatable brake piston assembly according to claim 1, wherein the brake piston has a lateral surface which, for guidance of the brake piston, is in direct contact with the first bore wall and/or wherein the rotation-translation transmission is a screw drive, wherein the internal space of the brake piston is defined by a cylindrical inner wall and wherein the brake piston is in the form of a screw nut, a thread or threads of which and/or a ball raceway or ball raceways of which are formed in the inner wall.

4. The electromechanically actuatable brake piston assembly according to claim 1, wherein the guide slot is formed in the first bore wall and recesses the first bore wall accordingly.

5. The electromechanically actuatable brake piston assembly according to claim 1, wherein the guide slot is in the form of an elongate hole, an longitudinal axis of which is oriented parallel to the bore axis of the first bore and which penetrates the brake piston bearing portion from an exterior of the brake piston bearing portion, in a radial direction toward the bore axis, to the first bore, wherein the guide element is at least partly accommodated in the guide slot.

6. The electromechanically actuatable brake piston assembly according to claim 1, wherein the brake piston bearing portion has a recess which is introduced into an exterior of the brake piston bearing portion and which has a recess bottom sunk into the brake piston bearing portion and a recess wall connecting the recess bottom and the exterior, so that the guide slot forms a through-hole between the recess bottom and the first bore, wherein the recess is and/or can be closed to the outside by a cover.

7. The electromechanically actuatable brake piston assembly according to claim 6, wherein the recess wall is cylindrical with a first inside diameter.

8. The electromechanically actuatable brake piston assembly according to claim 1, wherein the cover has a cover edge notched by at least one slit which proceeds from the cover edge and which extends toward a cover centre, so that the diameter of the cover edge is elastically variable, and/or wherein the cover has a cover edge notched by at least five slits which proceed from the cover edge and extend toward the cover centre and are mutually spaced apart so that the diameter of the cover edge is elastically variable.

9. The electromechanically actuatable brake piston assembly according to claim 8, wherein the cover has a planar inner cover portion which, in an installed state, covers the guide slot, wherein the cover edge surrounds the inner cover portion and protrudes from the inner cover portion by at least one first bent part, wherein the at least one slit or the at least five slits at least partly notch the at least first bent part.

10. The electromechanically actuatable brake piston assembly according to claim 8, wherein the cover edge is shaped such that the cover edge can be inserted into the recess because of elastic deformation and that the cover can be pulled out against the insertion direction only with plastic deformation of the cover edge and/or of the cover.

11. The electromechanically actuatable brake piston assembly according to claim 8, wherein the recess has an annular groove having a groove base or has a bore offset portion having a second bore wall, wherein the groove base or the second bore wall has a second inside diameter which is greater than the first inside diameter, and wherein the cover, in an inserted state, is form-lockingly held by its cover edge in the annular groove or in the bore offset portion, and wherein in this position the outside diameter of the cover edge is greater than the first inside diameter.

12. The electromechanically actuatable brake piston assembly according to claim 8, wherein the cover edge has, when not inserted in the recess, a first outside diameter and, when inserted in the recess, a second outside diameter which is less than the first outside diameter, wherein the cover edge is clamped in and/or presses into the recess wall when inserted in the recess.

13. The electromechanically actuatable brake piston assembly according to claim 6, wherein the electromechanically actuatable brake piston assembly comprises a seal which, together with the cover, seals off the anti-rotation mechanism and the first bore from other components of the electromechanically actuatable brake piston assembly.

14. The electromechanically actuatable brake piston assembly according to claim 13, wherein the seal is made of an elastically deformable elastomer.

15. The electromechanically actuatable brake piston assembly according to claim 13, wherein in the installed state the seal applies a force to the cover as a result of elastic deformation.

16. The electromechanically actuatable brake piston assembly according to claim 13, wherein the seal is annular and has a round or oval or polygonal cross section, wherein the seal is placed between the recess bottom and the first bent part or between the recess bottom and a second bent part which a cover edge comprises and which is located between the first bent part and an inner cover portion.

17. The electromechanically actuatable brake piston assembly according to claim 16, wherein at least most of the inner cover portion is planar, wherein the second bent part comprises an annular-disc-shaped portion, and wherein the planar inner cover portion and the annular-disc-shaped portion of the second bent part are oriented parallel to one another.

18. The electromechanically actuatable brake piston assembly according to claim 13, wherein the seal is annular and has a round or oval or polygonal cross section and wherein the seal is placed between the recess wall and the first bent part or between the recess wall and a second bent part which the cover edge comprises and which is located between the first bent part and the inner cover portion.

19. The electromechanically actuatable brake piston assembly according to claim 13, wherein the seal is disc-shaped and is arranged between the recess bottom and the cover, and/or wherein the seal is disc-shaped and is arranged between the recess bottom and a pressing disc, which is comprised by the electromechanically actuatable brake piston assembly and which is seated against the cover.

20. A motor vehicle disc brake comprising a brake bracket, an electromechanical drive, which has a transmission assembly and an electric motor, and a brake piston assembly according to claim 1, which brake piston assembly can be actuated by the electromechanical drive.

21. A partial method in the manufacturing of an electromechanically actuatable brake piston assembly according to claim 1, comprising at least the method steps of:
a) introducing the guide slot, proceeding from an exterior of the brake piston bearing portion, in a radial direction toward the bore axis, to the first bore,
b) drilling, spindling or milling the recess or drilling, spindling or milling the recess,
c) inserting a seal into the first recess or mounting the seal on a cover,
d) inserting the cover into the recess and locking a cover edge in an annular groove or inserting the cover into the recess and clamping a cover edge to a first recess wall.
